(19) United States
(12) Patent Application Publication
(10) Pub. No.: US 2004/0114732 A1
(43) Pub. Date: Jun. 17, 2004

(54) Apparatus and method for editable personalized ring back tone service

(75) Inventors: Kangil Choe, Cliffside Park, NJ (US); Dongsoo Har, Seoul (KR)

Correspondence Address: MORGAN LEWIS & BOCKIUS LLP, 1111 PENNSYLVANIA AVENUE NW, WASHINGTON, DC, 20004, US

(73) Assignee: CW Wireless Corporation

(21) Appl. No.: 10/400,695

(22) Filed: Mar. 28, 2003

Related U.S. Application Data
(60) Provisional application No. 60/433,219, filed on Dec. 13, 2002.

(51) Int. Cl. H04M 1/64

(52) U.S. Cl. 379/88.17

(57) ABSTRACT

A method and apparatus for an editable personalized ring back tone service in a telephone communication is disclosed in the present invention. The apparatus may include a master content provider server storing at least one personalized ring back message, an internet data center connected to the master content provider server and a participating telephone service provider for retrieving the personalized ring back message when a called party is the subscriber and delivering the personalized ring back message to be heard by a calling party while connecting to the called party, and an authoring tool for generating and editing the personalized ring back message to be uploaded to the master content provider through a public website.

This application claims the benefit of a provisional application, entitled, “A Business Model Based on Personalized Ring Back Tone Service and the Application Software Tools”, which was filed on Dec. 13, 2002, and assigned Provisional Application No. 60/433,219, which is hereby incorporated by reference.

### BACKGROUND OF THE INVENTION

1. Field of the Invention

The present invention relates to a phone system, and more particularly, to an apparatus and method for an editable personalized ring back tone service. Although the present invention is suitable for a wide scope of applications, it is particularly suitable for replacing the conventional ring back tone with an editable personalized ring back message, so that it provides both a subscriber and a ring back message content provider with commercial benefits.

2. Discussion of the Related Art

When a calling party calls a called party in the telephone communication, the calling party hears a monotonous ring back tone for a period of time before the called party picks up the phone. In order to effectively utilize this waiting period, there has been an attempt to replace the conventional ring back tone with a commercial message, music, news, and other commercial information. Thus, a calling party is provided with a commercial message instead of the conventional ring back tone, so that the calling party may be relieved from a tedious state.

However, the above commercial ring back tone services provided by the telecommunication service providers are very limited and often are not pertinent to the calling party. This is because the subscriber can download only a single desired audio file from an audio file data base provided by a communication network service provider through a web interface to the subscriber's communication terminal. Therefore, the audio files in this system are subject to a lack of dynamic contents because each file is provided as a single unit, and the audio file cannot be edited to meet the specific subscriber's needs and interests.

### SUMMARY OF THE INVENTION

Accordingly, the present invention is directed to an apparatus and method for an editable personalized ring back tone service that substantially obviates one or more of problems due to limitations and disadvantages of the related art.

Another object of the present invention is to provide an apparatus and method for an editable personalized ring back tone service that replaces a monotonous and function-oriented ring back tone with a business-oriented ring back tone.

Another object of the present invention is to provide an apparatus and method for an editable personalized ring back tone service that performs functions enabling commercial advertisements, voice messages, entertainment, and so on.

A further object of the present invention is to provide an apparatus and method for an editable personalized ring back tone service that allows individual or corporate subscribers to select or author their own ring back tone, whereby the ring back tone is uploaded to the server of a wireless/wired provider.

Additional features and advantages of the invention will be set forth in the description which follows and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a system for an editable personalized ring back tone service in a telephone communication includes a master content provider server storing at least one personalized ring back message, an internet data center connected to the master content provider server and a participating telephone service provider for retrieving the personalized ring back message when a called party is identified as a subscriber and delivering the personalized ring back message to be heard by a calling party while connecting to the called party, and an authoring tool for generating and editing the personalized ring back message to be uploaded to the master content provider through a public website.

In another aspect of the present invention, a method for providing an editable personalized ring back tone service in a telephone communication includes identifying a telephone communication between a calling party and a called party, determining whether the called party is a subscriber for the personalized ring back tone service, retrieving a personalized ring back message from a master content provider server storing at least one ring back message created through an authoring tool in a public website when the called party is the subscriber, and delivering the personalized ring back message to the calling party as a ring back tone while connecting to the called party.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention.

In the drawings:

FIG. 1 is a block diagram of a system for an editable personalized ring back tone service according to the present invention;

FIG. 2 is a flow chart illustrating a personalized ring back tone service process according to the present invention;

FIG. 3 is a flow chart illustrating a user account access process through an authoring tool for the personalized ring back tone service according to the present invention;

FIG. 4 is a flow chart illustrating a content provider account access process through an authoring tool for the personalized ring back tone service according to the present invention; and

FIG. 5 is a graphic user interface (GUI) of an authoring tool in a public website according to the present invention.

### DETAILED DESCRIPTION OF THE ILLUSTRATED EMBODIMENTS

Reference will now be made in detail to the illustrated embodiments of the present invention, examples of which are illustrated in the accompanying drawings. Wherever possible, the same reference numbers will be used throughout the drawings to refer to the same or like parts.

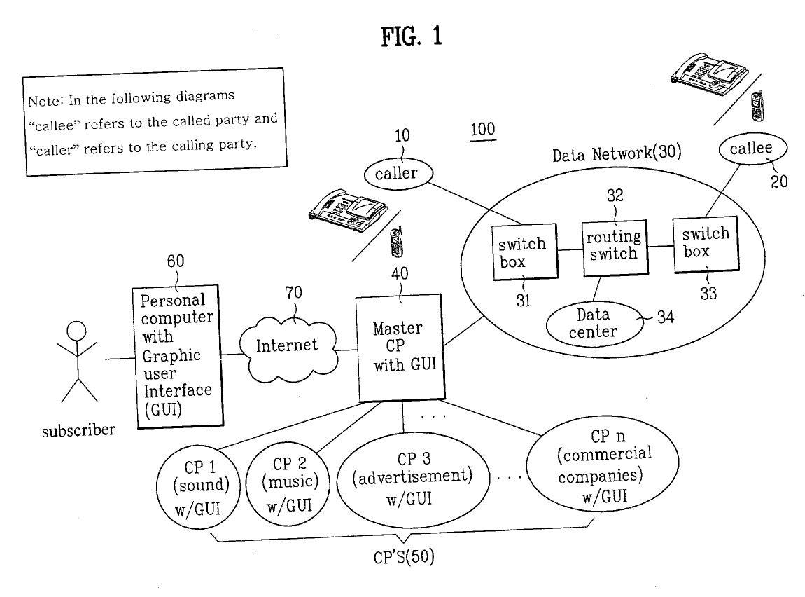

FIG. 1 is a block diagram of a system for an editable personalized ring back tone service according to the present invention. As shown in FIG. 1, implementation of an editable personalized ring back tone service 100 of the present invention requires a master content provider 40, a participating telephone service provider 30, a content provider 50 including an advertisement company, and a subscriber 60 for the ring back tone service.

The master content provider (MCP) 40 supplies various contents provided by the content provider 50 for replacing a mechanical and monotonous conventional ring back tone with a personalized ring back message. The master content provider 40 supplies a physical connection between the participating telephone service provider 30 and the content provider (CP) 50 through a master CP gateway. The content provider 50 provides commercially paid ring back tone templates to individual subscribers via an automatic response system (ARS) or a public website and uploads the ring back tone template selected by each user to a master content provider server within a network provider's premises. The master content provider 40 supplies CP's 50 with a gateway to the telephone service provider's network 30. The master CP's 40 can take the role of the CP, by providing ring back tone templates. Similarly, a telephone network provider can play the role of the MCP and/or the CP's, locating all the necessary physical equipment within its premises.

The contents of the personalized ring back message may be created and/or modified by the service subscribers 60 or the content providers 50 through a graphic user interface (GUI) of an authoring tool in a public website 70. In addition, the master content provider 40 and the telephone service network provider 30 may also provide predetermined templates for the personalized ring back message if it includes all the necessary equipment.

The master content provider 40 has an MCP server storing ring back messages created by the service subscriber 60 or provided by the content providers 50. An internet data center 34 connected to the participating telephone service provider 30 retrieves the ring back messages from the MCP server, when a called party 20 is the service subscriber, and delivers the personalized ring back message to a calling party 10, while the calling party 10 waits for connection to the called party 20, as a ring back tone.

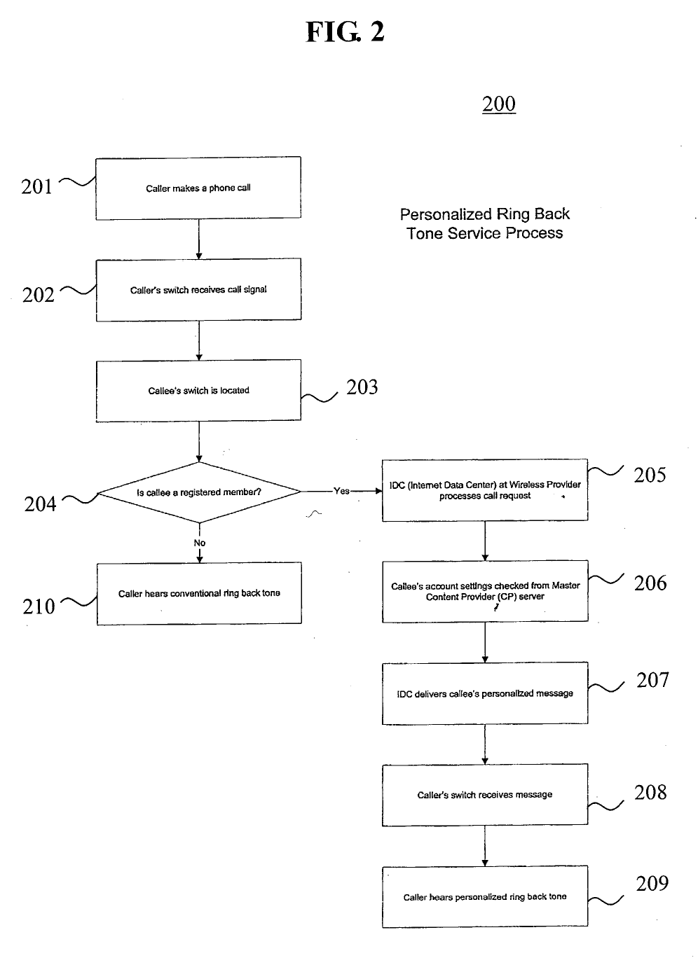

FIG. 2 is a flow chart illustrating a personalized ring back tone service process 200 according to the present invention.

When a calling party using a wired telephone or wireless handset or other form of equivalent device dials a called party's number 201, a caller's switch detects the call signal 202 and searches for the called party's switch for a connection 203. If the line is busy, the calling party hears the conventional busy signal. If the called party is available, the personalized ring back tone (PRBT) system determines whether the called party is a service subscriber.

Thereafter, the system 200 determines whether the called party is a subscriber 204. If the called party is not a subscriber, the calling party hears the conventional ring back tone 210. If the called party is a subscriber, the PRBT system accesses to the Internet Data Center (IDC) located at a participating telephone service provider to retrieve the message settings based on the subscriber's account information stored in the MCP server 205, 206, and 207. The IDC delivers the called party's personalized ring back message to the calling party's switch 208, so that the calling party hears the ring back message 209.

The MCP server may be a standalone system that connects to an originating switch and a terminating switch, or a built-in module that is a component of either an originating switch or a terminating switch. In case of an intelligent network, related equipment may be a service control point (SCP), a service switching point (SSP), and other necessary modules to implement the personalized ring back tone service.

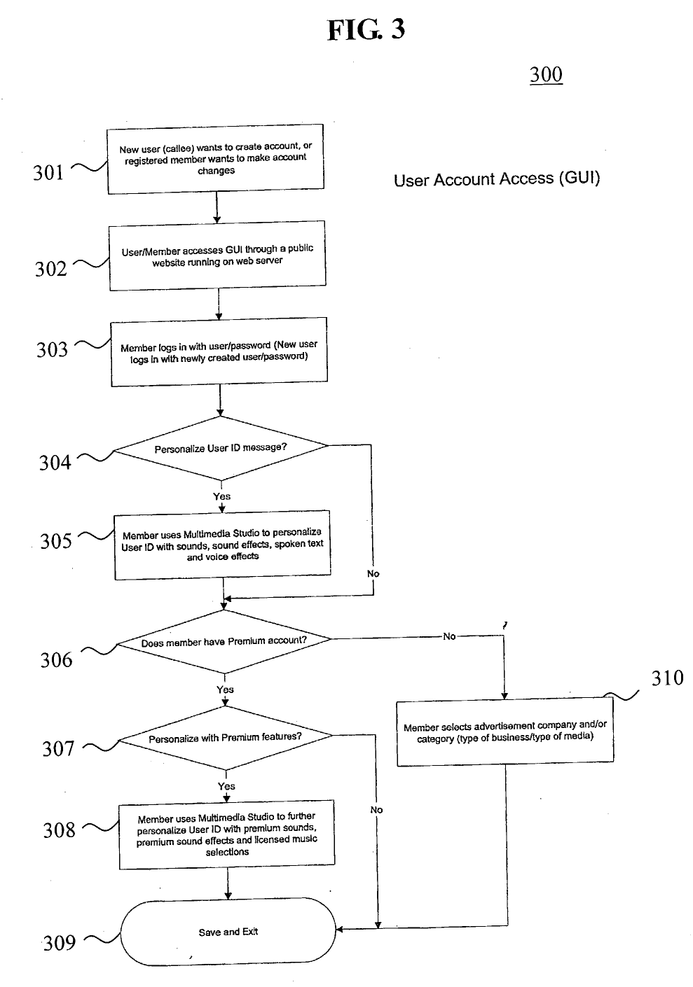

FIG. 3 is a flow chart illustrating a user account access process 300 through an authoring tool for the personalized ring back tone service according to the present invention.

A service subscriber of the PRBT service accesses the member graphic user interface (GUI) through a public website running on the PRBT web server 301 and 302. The member logs in with the username and password to access the account 303. Alternatively, a new user may create an account and then log in using the newly created username and password.

The next step is to determine whether the subscriber wishes to personalize his/her message 304. If the subscriber wishes to personalize the message, he/she uses the multimedia studio of the authoring tool 305.

If the subscriber does not wish to personalize the message, the next step is to determine whether the subscriber has a basic account or a premium account 306 and 307. If the subscriber is registered for “basic service” (e.g., paying a substantially reduced monthly fee or nothing), he/she can use the multimedia studio of the authoring tool to personalize the user ID message with sounds, sound effects, spoken text, and voice effects. Also, the subscriber may select the type of commercial messages to be heard by a caller according to a company name or a business sector as well as available media formats 310, so that a calling party is required to hear commercial messages as a ring back tone. If the subscriber does not select the type of advertisement, default settings are used.

If the subscriber is registered for a fee-based “premium service” (e.g., paying a regular monthly fee), he/she can use the multimedia studio of the authoring tool to personalize the user ID message with all components available to the basic service as well as the premium licensed sounds and music. Unlike the basic service subscriber, the caller will not hear any commercial messages as a part of the PRBT service.

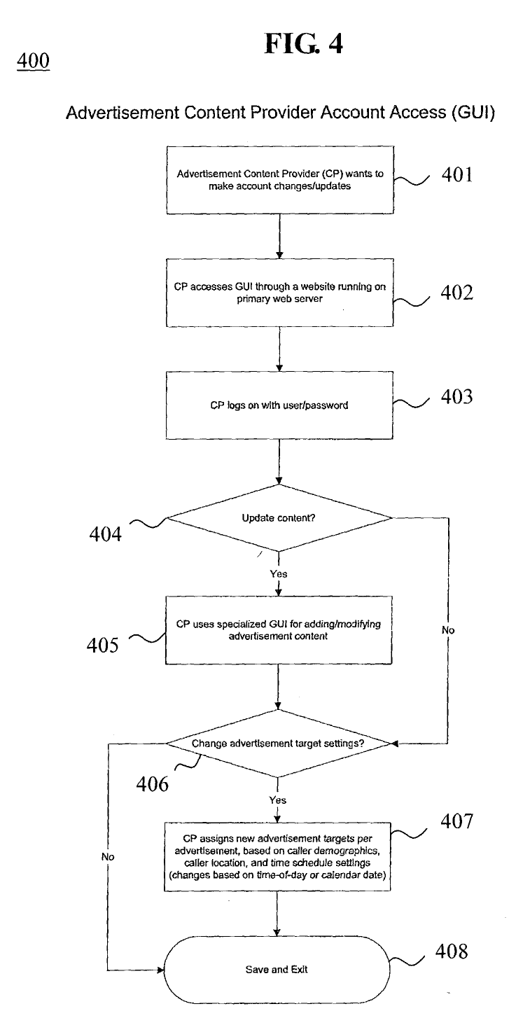

FIG. 4 is a flow chart illustrating a content provider account access process 400 through an authoring tool for the personalized ring back tone service according to the present invention.

A registered advertisement content provider may access the CP graphic user interface (GUI) through a private website running on the PRBT web server 401 and 402. The CP logs in with its username and password to access the account 403. The CP can use a specialized GUI to add or update advertisement contents and modify advertisement target settings 404 and 405. The advertisement target setting includes calling party's demographics, location, and time schedule settings. Advertisement can be tailored to the calling party's time-of-day, the calendar date, holidays, or other specific time periods 407.

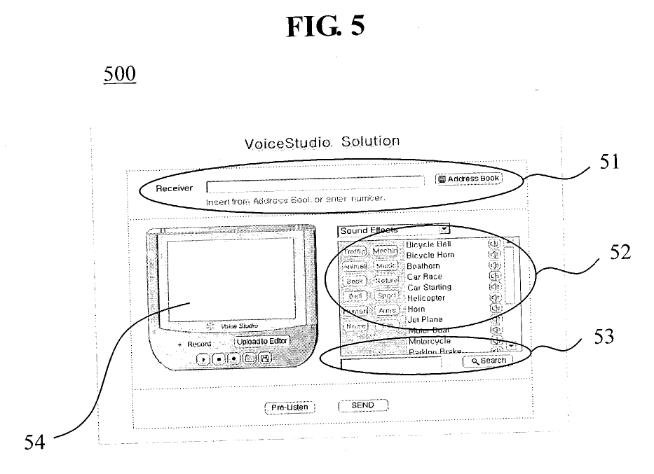

FIG. 5 is a graphic user interface (GUI) of an authoring tool 500 in a public website according to the present invention.

To meet the variety of demands of ring back tone service subscribers, a user-friendly authoring tool having a graphic user interface (GUI) is provided via the Internet. As shown in FIG. 5, the authoring tool has a telephone number data base 51, a pre-constructed content data base 52, an importing content tool 53, and an on-screen editing panel voice simulation tool 54.

A user picks up sound templates or other types of templates of image and video from the pre-constructed content database 52. Each category, such as sports, includes a set of elementary templates, for example, “Bicycle Bell”. User-selected templates will appear in the left window in the order of selection. User-recorded messages could be uploaded from a personal PC or its equivalent and can be used as a part of or the entire ring back tone.

Also, a user can designate a phone number for which the authored ring back tone is to be used by inputting the number in a separate window at the top of the user interface. Authored ring back tones can be listened by pressing a “Pre-Listen” button beneath the left window before getting uploaded to the server managed by a carrier. If the user is satisfied with the way it plays, the user presses a “SEND” button to upload to the ring back tone server of the service provider.

As described above, the personalized ring back tone service system in the present invention replaces the conventional mechanical ring back tone with a business-oriented ring back tone. Thus, an advertisement agency uses the personalized ring back tone service system in the present invention for a targeted advertisement by managing a data base sorted by age group, geographical area, and occupation, etc. Also, subscribers can save money on their telephone bills by allowing such targeted commercial message to replace the conventional ring back tone in their telephone communication.

In addition, the personalized ring back tone service system in the present invention enables any corporate content providers to provide a corporate ring back tone for their employees' personal phones, so that the employees can also have the benefit of getting sponsorship of their personal telephone bills.

It will be apparent to those skilled in the art that various modifications and variations can be made in the apparatus and method for an editable personalized ring back tone service of the present invention without departing from the spirit or scope of the inventions. Thus, it is intended that the present invention covers the modifications and variations of this invention provided they come within the scope of the appended claims and their equivalents.

What is claimed is:

1. A system for an editable personalized ring back tone service in a telephone communication, the system comprising:
a master content provider server storing at least one personalized ring back message;
an internet data center connected to the master content provider server and a participating telephone service provider for retrieving the personalized ring back message when a called party is identified as a subscriber and delivering the personalized ring back message to be heard by a calling party while connecting to the called party; and
an authoring tool for generating and editing the personalized ring back message to be uploaded to the master content provider through a public website.

2. The system according to claim 1, wherein the personalized ring back message includes a message block having a user ID message identifying the called party, and a message block body to carry information for the calling party.

3. The system according to claim 2, wherein the user ID message includes one of a sound, a text, an image, a voice, and any combination thereof.

4. The system according to claim 3, wherein the sound and the voice are in a file format including one of wav, pcm, au, aiff, and mp3, the text is in a file format including one of txt, doc, and rtf, and the image is in a file format including one of gif, jpg, jfif, and tiff.

5. The system according to claim 1, wherein the called party is identified by at least one of the called party's own recorded voice, any number of simulated voices, personalized messages and information, and any combination thereof.

6. The system according to claim 1, wherein the personalized ring back message is created or modified by the subscriber through the authoring tool or by an operator at a customer service call center based on requests by the subscriber through the participating telephone service provider.

7. The system according to claim 1, wherein the content provider creates or modifies the personalized ring back message comprising a commercial message, a sound, a music, and other multimedia, such as pictures, movie clips, and animations by using the authoring tool.

8. The system according to claim 1, wherein the personalized ring back message includes a targeted message depending on an identity or a location of the calling party.

9. The system according to claim 8, wherein the identity of the calling party includes family members, co-workers, and unknown callers.

10. The system according to claim 8, wherein the targeted message is personalized by the subscriber so that a distinct calling party hears a distinct commercial message.

11. The system according to claim 8, wherein the targeted message is personalized by the content provider so that a calling party hears a distinct commercial message based on a specific location of the calling party.

12. The system according to claim 1, wherein the targeted message is personalized by the content provider based on a specific date or time period.

13. The system according to claim 1, wherein the personalized ring back message includes a specific message depending on a scheduled time or a date event.

14. The system according to claim 1, wherein the authoring tool has a scheduler to select a specific date and a period of time by personalizing a specific user ID message to announce important events within the personalized ring back message.

15. The system according to claim 1, wherein the authoring tool has a scheduler to select a specific date or a period of time selected by the called party to incorporate a specific commercial appropriate for a certain date or time period into the personalized ring back message.

16. The system according to claim 1, wherein the personalized ring back message created by using the authoring tool is uploaded to an automatic response system (ARS) accessible through interactive VXML prompts to select predetermined sounds and music.

17. The system according to claim 1, wherein the personalized ring back message is updated by a content provider through a graphic user interface (GUI).

18. The system according to claim 1, wherein the personalized ring back tone service provides the content provider with advertisement statistics and demographics information.

19. The system according to claim 1, wherein the personalized ring back message excludes a commercial message in exchange for a monthly subscription fee.

20. The system according to claim 1, wherein the personalized ring back message is created by the subscriber of the ring back tone service or provided by at least one content provider.

21. The system according to claim 1, wherein the authoring tool includes a telephone number data base, a pre-constructed content data base, a content importing tool, and an on-screen editing tool for voice manipulation and simulation.

22. A method for providing an editable personalized ring back tone service in a telephone communication, comprising:
identifying a telephone communication between a calling party and a called party;
determining whether the called party is a subscriber for the personalized ring back tone service;
retrieving a personalized ring back message from a master content provider server storing at least one ring back message created through an authoring tool in a public website when the called party is the subscriber; and
delivering the personalized ring back message to the calling party as a ring back tone while connecting to the called party.

23. The method according to claim 22, wherein the personalized ring back message includes a message block having a user ID message identifying the called party and a message block body to carry information for the calling party.

24. The method according to claim 23, wherein the message block body includes one of a sound, a text, an image, a voice, and any combination thereof.

25. The method according to claim 24, wherein the sound and the voice are in a file format including one of wav, pcm, au, aiff, and mp3, the text is in a file format including one of txt, doc, and rtf, and the image is in a file format including one of gif, jpg, jfif, and tiff.

26. The method according to claim 22, wherein the called party is identified by at least one of the called party's own recorded voice, any number of simulated voices, personalized messages and information, and any combination thereof.

27. The method according to claim 22, wherein the personalized ring back message is created or modified by the subscriber through the authoring tool or by an operator at a customer service call center based on requests by the subscriber through the participating telephone service provider.

28. The method according to claim 22, wherein the personalized ring back message includes a commercial message, a sound, music, pictures, movie clips, and animations by using the authoring tool.

29. The method according to claim 22, wherein the personalized ring back message includes a targeted message depending on an identity or a location of the calling party.

30. The method according to claim 29, wherein the identity of the calling party includes family members, co-workers, and unknown callers.

31. The method according to claim 29, wherein the targeted message is personalized by the subscriber so that a distinct calling party hears a distinct commercial message.

32. The method according to claim 29, wherein the targeted message is personalized by the content provider so that a calling party hears a distinct commercial message based on a specific location of the calling party.

33. The method according to claim 22, wherein the targeted message is personalized by the content provider based on a specific date or time period.

34. The method according to claim 22, wherein the personalized ring back message includes a specific message depending on a scheduled time or a date event.

35. The method according to claim 22, wherein the authoring tool has a scheduler to select a specific date and a period of time by personalizing a specific user ID to announce important events within the personalized ring back message.

36. The method according to claim 22, wherein the authoring tool has a scheduler to select a specific date or a period of time selected by the called party to incorporate a specific commercial appropriate for a certain date or time period into the personalized ring back message.

37. The method according to claim 22, wherein the personalized ring back message created by using the authoring tool is uploaded to an automatic response system (ARS) accessible through interactive VXML prompts to select predetermined sounds and music.

38. The method according to claim 22, wherein the personalized ring back message is updated by a content provider through a graphic user interface (GUI).

39. The method according to claim 22, wherein the personalized ring back tone service provides a content provider with advertisement statistics and demographics information.

40. The method according to claim 22, wherein the personalized ring back message excludes a commercial message in exchange for a monthly subscription fee.

41. The method according to claim 22, wherein the personalized ring back message is created by the subscriber of the ring back tone service or provided by at least one content provider.
